(19) United States
(12) Patent Application Publication
(10) Pub. No.: US 2007/0187214 A1
(43) Pub. Date: Aug. 16, 2007

(54) Flexible conveyor for conveying exceptionally heavy loads

(76) Inventor: Joan Anton Halbesma, Waardhuizen (NL)

Correspondence Address: QUARLES & BRADY LLP, 411 E. WISCONSIN AVENUE, SUITE 2040, MILWAUKEE, WI, 53202-4497, US

(21) Appl. No.: 10/576,828

(22) PCT Filed: Oct. 23, 2003
(86) PCT No.: PCT/NL03/00721

§ 371 Date: Mar. 19, 2007

(51) Int. Cl. B65G 17/06

(52) U.S. Cl. 198/853

(57) ABSTRACT

The invention relates to a conveyor for moving very heavy loads, consisting of a chain having widthwise multiple links and wherein, in longitudinal direction, the links are alternately of plastic and steel while the chain is provided as its bottom side with a continuous, one-piece rubber band. In order to have the conveyor move very heavy loads, it is provided that the plastic links in the chain have a combined bearing and pulling function and in themselves form a sleeve bearing with their underground.

The invention relates to a conveyor for moving very heavy loads, consisting of a chain having widthwise multiple links and wherein in the longitudinal direction, links are alternately of plastic and steel, the chain being provided at the supporting side with a continuous, one-piece rubber band.

Such a chain is known inter alia with multi-chain chains. However, with the aid of these known chains, very heavy loads can only be pulled or hoisted because such a chain does not provide in a bearing function.

The object of the invention is to obtain such, an apparatus with the aid of which very heavy loads can be moved in a dragging manner with limited forces.

According to the invention, this can be achieved in that the plastic links in the chain have a combined bearing and pulling function and in combination with their underground simultaneously form a sleeve bearing. The relatively large bearing surface of the plastic links reduces the specific surface pressure of the very high static and dynamic loads. When using roller bearings such as ball bearings and needle bearings, the bearing surface is extremely small and such forces would be destructive.

When using a conveyor according to the invention, the very heavy object to be conveyed is borne by the plastic links lying on an underground such that the very heavy load can be slidingly pulled forward thereover with relatively small forces.

The invention will be set forth hereinbelow on the basis of an exemplary embodiment of the construction according to the invention represented in the drawing.

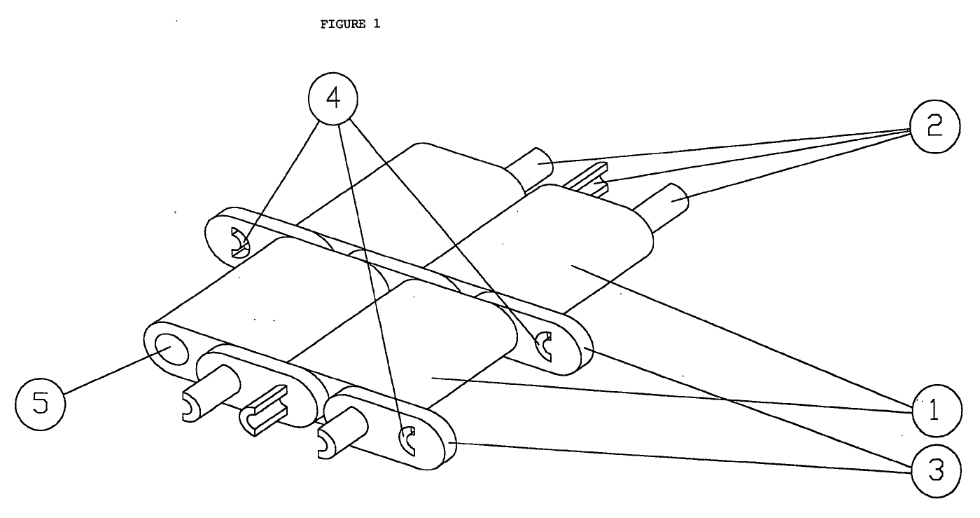

FIG. 1 schematically shows the composition of the conveyor chain according to the invention while for the sake of clarity of the Figure, certain parts have been omitted; and

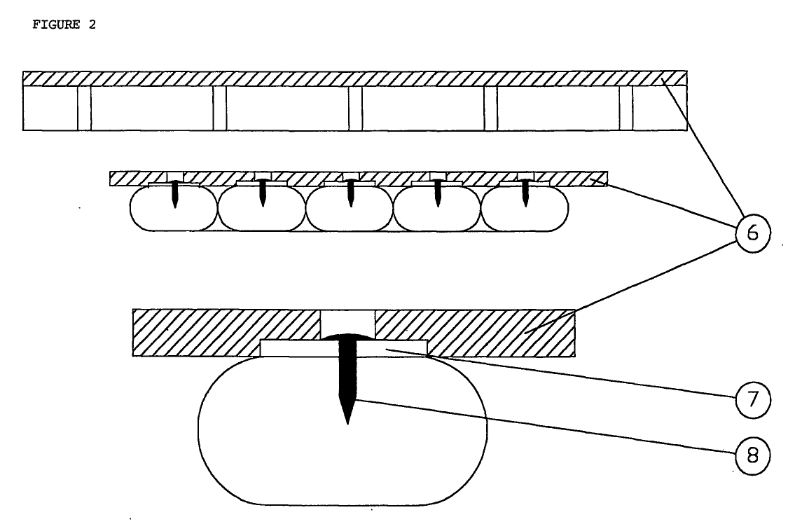

FIG. 2 shows the two side views of FIG. 1.

The conveyor chain comprises several plastic links (1) located, viewed in FIG. 1, side by side. Through the plastic links located side by side and in one line, a one-piece metal connecting pin (2) extends, connecting the plastic links mutually and to a following row of metal links (3) located side by side, in one line and partly between the plastic links in a manner such that the metal connecting pin (2) can hingingly move the metal links (3) relative to the plastic links but also such that the connecting pin (2) cannot move relative to the metal links (3). To this end, the connecting pin has the shape of a tube halved in longitudinal direction, and the metal links have a matching recess (4). The plastic links have round holes (5). Thus, mutual pivotal movement and hence wear of the metal connecting pins (2) in the metal links (3) is prevented, and use is made of the high resistance to wear when pivoting the half-round metal connecting pins (2) in the round hole of the plastic link (5).

In order to maintain the tensile strength the same throughout in the entire chain, with the height of the two types of links remaining the same, the width of the plastic links (1) relative to the width of the metal links (3) is selected to be inversely proportional to the specific tensile strength of the two materials. In other words: the tensile strength of the total of the metal links of one row is equal to the tensile strength of the total of the plastic links of a following row.

The thus obtained relatively wide plastic links (1) therefore also form the largest surface of the chain (approximately 90%). This surface is determinative to the load bearing capacity of the conveyor and will be dependent on the selected plastic.

In order to guarantee the favorable sleeve bearing property of the chain relative to its underground, pollution between the two sliding parts is to be prevented. By selecting the height of the plastic links and metal links to be equal, both types of links abut on the underground. Due to thus created compartmentation of the openings between the successive plastic links, pollution via the side of the chain can be limited to a minimum. A continuous, one-piece rubber band (6) provided on top of the chain protects against pollution from above, and, together with the metal links, completely closes off the sliding parts.

The attachment of the continuous, one-piece rubber band is mechanical and is done on the plastic links. To this end, width-wise of the rubber band, metal strips (7) are vulcanized along which are positioned and drilled through such that attachment to the plastic links can take place by means of, for instance, screws (8).

The plastic links are to have a limited friction coefficient relative to the underground over which they slide. Different combinations can be used such as, for instance, links of POM (polyoxymethylene) on a carrier with an oil-filled nylon top layer.

1. A conveyor for moving very heavy loads, consisting of a chain having width-wise multiple solid links and wherein, in the longitudinal direction, the multiple solid links are alternately of plastic and metal, wherein the plastic links have both a bearing and a pulling function and simultaneously form a sleeve bearing with the underground over which they drag.

2. A conveyor according to claim 1, wherein the chain is provided at the bottom side with a continuous one-piece rubber band mechanically attached thereto.

3. A conveyor according to claim 1, wherein the plastic links and the metal links have the same height.

4. A conveyor according to claim 1, wherein the metal connecting pin connecting the multiple solid links of one row to each other and to the following row of multiple sold links, consist of one piece.

5. A conveyor according to claim 1, wherein the metal connecting pin connects of multiple solid links of one row to each other and to the following row of multiple solid links in a manner such that it cannot move relative to the metal links but that it can hingingly move the metal links relative to the plastic links.

6. A conveyor according to claim 1, wherein the width of the links is inversely proportional relation to the specific tensile strength of the materials from which they have been composed.

7. A conveyor according to claim 1, wherein the underground over which the conveyor drags has a top layer of a nylon filled with a lubricant.

8. A conveyor according to claim 1, wherein the plastic links consist of the plastic POM.
